(19) United States
(12) Patent Application Publication
(10) Pub. No.: US 2011/0191492 A1
(43) Pub. Date: Aug. 4, 2011

(54) ROUTER, ROUTING METHOD, INFORMATION PROCESSING APPARATUS, AND METHOD OF CONSTRUCTING VIRTUAL MACHINE

(75) Inventor: Yuji Imai, Kawasaki (JP)

(73) Assignee: FUJITSU LIMITED, Kawasaki-shi (JP)

(21) Appl. No.: 13/016,455

(22) Filed: Jan. 28, 2011

(30) Foreign Application Priority Data
Feb. 2, 2010 (JP) 2010-21666

(51) Int. Cl. G06F 15/173

(52) U.S. Cl. 709/238

(57) ABSTRACT

A method of constructing a virtual machine includes receiving information specifying processing power of an information processing apparatus to be provided from a router connected through a virtual private network to an external apparatus connected through the router; constructing a virtual machine satisfying the processing power specified by the information; and transmitting information regarding the virtual machine to the router.

### CROSS-REFERENCE TO RELATED APPLICATIONS

This application is based upon and claims the benefit of priority of the prior Japanese Patent Application No. 2010-21666, filed on Feb. 2, 2010, the entire contents of which are incorporated herein by reference.

### FIELD

The embodiments discussed herein are related to technology for routing, information processing and a virtual machine.

### BACKGROUND

To date, there have been known techniques which make it easy for a purchaser of a router to perform setting for an Internet connection in the router by obtaining setting information of the router for connection to an Internet service provider (ISP) via a network. In these techniques, when a router is connected to a modem, the router accesses a broadband access server. After having been authenticated by a RADIUS server, the router is subjected to device authentication by a device authentication server. After that, the router obtains setting information to be used at the time of connection to an ISP server from an ISP download server. The router performs setting of the obtained setting information in the router itself, and connects to the ISP server on the basis of the setting information. Thus, the router obtains HTML codes of a Web page, e.g., on the Internet through the ISP server.

Also, to date, techniques for using a system utilizing a virtual machine on a cloud data center from a customer's intranet have been known. In this system, a physical server in the cloud data center starts a virtual machine which performs the customer's operation, and provides terminals (for example, computers) connected to the customer's intranet with services allowed to be used by the customer's operation.

However, in related-art techniques, an engineer of the cloud data center needs to carry out logical design of a system including a virtual machine and construction work in response to a customer's request. Also, the customer needs to conduct setting work for connecting to the virtual machine of the cloud data center. Accordingly, there has been a problem in that the workload is imposed on the engineer of the cloud data center and the customer.

At the time of installation of a router in a customer's intranet, if a customer's terminal automatically accesses a virtual machine in a cloud data center through the customer's intranet and the router, the workload can be alleviated. However, there is a problem in that a virtual machine accessed by a customer's terminal in a cloud data center is fixed.

### SUMMARY

According to a certain aspect of the invention, a router includes a routing unit performing routing between a virtual private network and an external apparatus; a reading unit reading, from a recording medium, information specifying processing power of an information processing apparatus communicating with the external apparatus through the virtual private network; and a requesting unit transmitting the information read by the reading unit and requesting provision of an information processing apparatus satisfying the specification of the processing power.

The object and advantages of the invention will be realized and attained by at least the features, elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example of a system including a router according to a first embodiment.

FIG. 2 illustrates an example of a system including a router according to a second embodiment.

FIG. 3 illustrates an example of a database.

FIG. 4 illustrates an example of an IT cell.

FIG. 5 illustrates an example of a router managing unit of a managing server.

FIG. 6 illustrates an example of a router.

FIG. 7 illustrates an example of a router.

FIG. 8 illustrates an example of a flowchart of a process conducted by a router.

FIG. 9 illustrates an example of a flowchart of a process conducted by a router managing unit.

FIG. 10 illustrates an example of a flowchart of a process conducted by an IT cell managing unit.

FIG. 11 illustrates an example of a flowchart of a process conducted by an IT cell having a virtual machine that starts Web server.

FIG. 12 illustrates an example of a sequence of a process conducted by an information managing system.

FIG. 13 illustrates an example of a sequence of a process conducted by an information managing system.

### DESCRIPTION OF EMBODIMENTS

In the following, detailed descriptions will be given of embodiments of a router, a routing method, a routing program, an information processing apparatus, a virtual-machine construction method, and a virtual-machine construction program, which have been disclosed in the application concerned, with reference to the drawings. In this regard, the present invention is not limited to the following specific embodiments.

### First Embodiment

### System Configuration

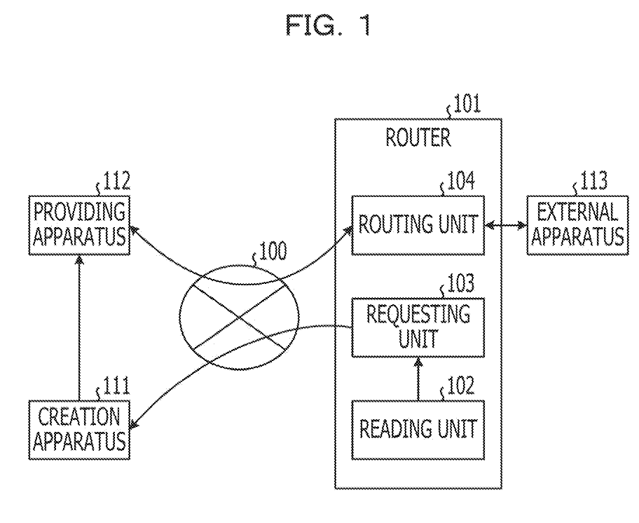

FIG. 1 is a system configuration including a router according to a first embodiment. The router 101 shown in FIG. 1 is connected to a network 100 and an external apparatus 113 (may be one or plural). The router 101 relays communication between an information processing apparatus connected to the network 100, which is a virtual private network, and an external apparatus 113. The information processing apparatus indicates, for example, a creation apparatus 111 and a provisioning apparatus 112.

For example, assuming that the provisioning apparatus 112 connected to the network 100 is a server as an information processing apparatus, when the server communicates with the external apparatus 113, the external apparatus 113 can use this server as if connected by a LAN (Local Area Network).

Accordingly, by connecting an information processing apparatus having processing power to be used from the external apparatus 113 to the network 100, it is possible to provide the external apparatus 113 with various kinds of services. It becomes possible for the external apparatus 113, that is to say, a user to use a virtual information processing apparatus by installing and setting a router without purchasing a server machine, for example.

The settings of the information processing apparatus used by the user include, for example, specification of an OS of the information processing apparatus to be used, an HDD capacity, a memory capacity, and the like. The router 101 shown in FIG. 1 has a reading unit 102 and a requesting unit 103 in order to reduce the workload of the setting work.

The reading unit 102 reads information (information specifying processing power) which specifies processing power of an information processing apparatus to be used with the use of the external apparatus 113 from a recording medium. The requesting unit 103 transmits information read by the reading unit, and requests provision of the information processing apparatus meeting the specification of the processing power. On the recording medium, for example, information on an OS, an HDD capacity, a memory capacity, and the like, of the information processing apparatus to be used is written before shipment in advance, for example. In this case, the user selects and purchases a recording medium on which information meeting the information processing apparatus to be used is recorded using the external apparatus 113.

Specifically, the requesting unit 103 transmits the information to the creation apparatus 111, which is an apparatus having a network address specified in advance. The creation apparatus 111 assigns the provisioning apparatus 112, which is an information processing apparatus meeting the processing power specified in the received information, to the router 101.

The routing unit 104 of the router 101 performs routing between the network 100 and the external apparatus 113 so as to relay communication between the provisioning apparatus 112 and the external apparatus 113. Accordingly, it is possible for the external apparatus 113 to use the provisioning apparatus 112 as an apparatus assigned to the external apparatus 113 itself.

### Summary of First Embodiment

As described above, the router 101 disclosed in the present embodiment performs setting by reading information, which specifies the processing power of an information processing apparatus to be provided, from a recording medium. Accordingly, the user may select and purchase a recording medium on which processing power to be used is recorded as information, and to set the medium in the router 101. Thereby, it is possible to install (provide) a virtual information processing apparatus by reducing the setting workload of a user.

### Second Embodiment

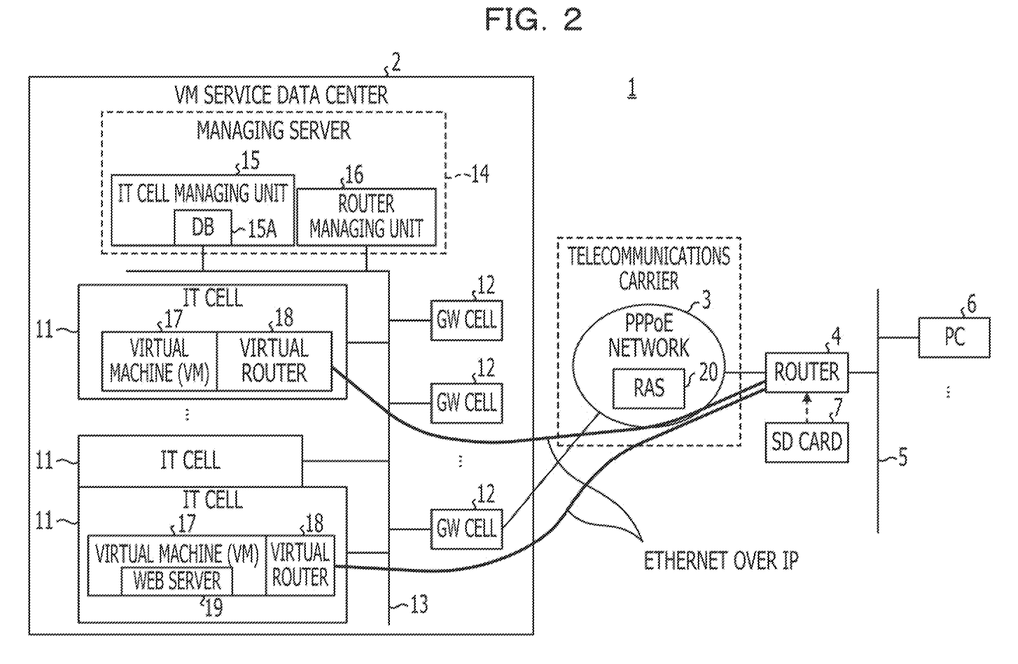

FIG. 2 is a configuration diagram of an information managing system including a router according to a second embodiment. The information managing system 1 shown in FIG. 2 includes a VM (Virtual Machine) service data center 2, a PPPoE (Point-to-Point Protocol over Ethernet (registered trademark)) net 3 provided by a telecommunications carrier, a router 4, a customer intranet 5, and a customer PC (Personal Computer) 6.

PPPoE is a protocol using a function of PPP (Point to Point Protocol) through Ethernet (registered trademark), and is a protocol for a virtual private network described later. The PPPoE net 3 is a wide-area network (WAN). The router 4 is a cloud-computing router for connecting to the VM service data center 2. Also, the router 4 may be directly connected to the customer PC 6. The customer PC 6 is given as an example of the external apparatus.

The VM service data center 2 is a cloud-computing service center which provides the customer PC 6 with services, such as a software package and an application execution platform, for example, through the PPPoE net 3. Also, the VM service data center 2 includes a plurality of IT (Information Technology) cells 11 constructed by a physical server, a plurality of GW (Gateway) cells 12 constructed by a gateway server, and a managing server 14.

The managing server 14 is connected to a plurality of IT cells 11 and a plurality of GW cells 12 through a LAN (Local Area Network) 13. The IT cell 11 is an example of an information processing apparatus. The managing server 14 is an example of an information managing apparatus.

The IT cell 11 includes a virtual machine 17 starting services provided to the customer PC 6, and a virtual router 18 controlling data output from the virtual machine 17 and data input to the virtual machine 17. The virtual machine 17 is connected to the virtual router 18 with a one-to-one relationship. Also, the IT cell 11 may include a plurality of virtual machines 17 and a plurality of virtual routers 18. The virtual machine 17 starts a virtual OS, applications to be provided to the customer, for example. The virtual machine 17 and the virtual router 18 are achieved by software. Also, the virtual router 18 is a firewall router that accepts accesses only from a specific customer PC.

The GW cell 12 has a gateway program, and exchanges data between the virtual router 18 and the PPPoE net 3 by executing the gateway program.

The managing server 14 includes an IT cell managing unit 15 (and a router managing unit 16. The IT cell managing unit 15 includes a database (DB) 15A.

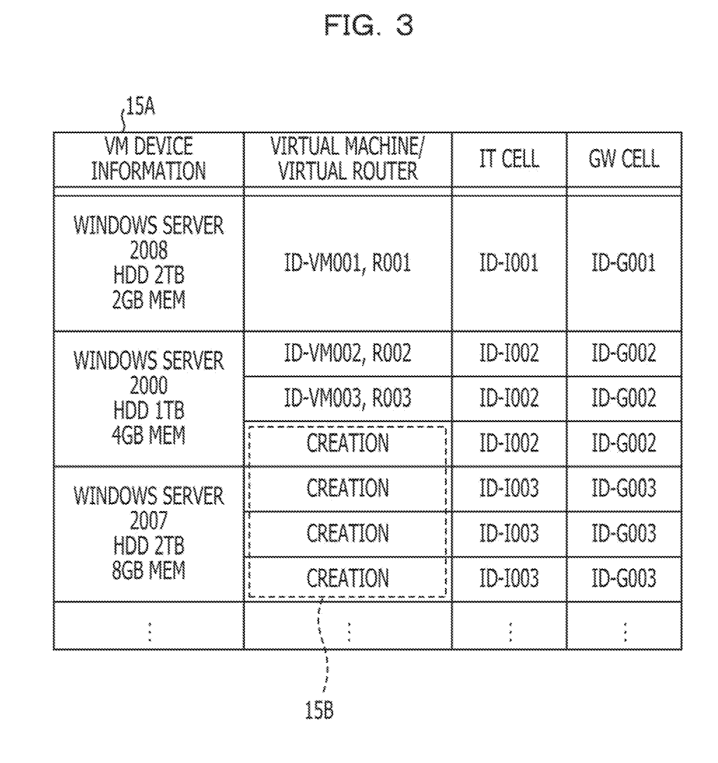

FIG. 3 is a structure diagram of the database 15A. The database 15A stores ID numbers of a virtual machine, a virtual router, an IT cell, and a GW cell, which are related to the VM device information received from the router 4. The VM device information is information identifying the IT cell 11 that starts the virtual machine 17 and the virtual modem 18. Specifically, the VM device information is information on the OS (Operating System) held by the IT cell 11 and hardware resources held by the IT cell 11. Also, the VM device information is an example of information on the information processing apparatus.

In the example in FIG. 3, the OS's are “Windows Server 2008”, “Windows Server 2000”, and “Windows Server 2007”. The hardware resources are “HDD 2TB, 2GB mem”, “HDD 1TB, 4GB mem”, and “HDD 2TB, 8GB mem”. In FIG. 3, a cell 15B cell of the database 15A is “creation”. This indicates that the IT cell 11 creates a new virtual machine 17 and a new virtual modem 18.

When the IT cell managing unit 15 receives VM device information from the router 4, the IT cell managing unit 15 selects a virtual machine 17, a virtual modem 18, an IT cell 11, and a GW cell 12 that are stored in the database 15A on the basis of the VM device information. The IT cell managing unit 15 starts the selected IT cell 11 and GW cell 12. At this time, if the cell 15B of the database 15A is “creation”, the IT cell managing unit 15 stores ID numbers of a new virtual machine 17 and a new virtual modem 18 into the database 15A, and creates and starts a new virtual machine 17 and a new virtual modem 18.

The IT cell managing unit 15 manages the operation of each IT cell 11. Also, the router managing unit 16 establishes a PPPoE communication session between the router 4 and the GW cell 12 on an IP-VPN (IP-Virtual Private Network) having been set up by a telecommunications carrier. The IP-VPN is a virtual private network (VPN) built through a wide-area IP communication network possessed by the telecommunications carrier. In FIG. 2, the IP-VPN is a virtual private network (VPN) connecting from the VM service data center 2 to the router 4 through the PPPoE net 3. As an example of an IP-VPN, there are FLET'S•VPN wide, FENICS business IP network service, for example, which are provided by telecommunications carriers.

Also, the router managing unit 16 notifies the IP address of the virtual router 18 to the router 4, notifies the IP address of the router 4 to the virtual router 18, and establishes communication between the router 4 and the virtual router 18 by Ethernet over IP. Further, the router managing unit 16 requests the IT cell managing unit 15 to assign a GW cell 12, which performs communication via the PPPoE session, to the IT cell 11 starting the virtual machine 17. The IT cell managing unit 15 and the router managing unit 16 are included in one managing server, but may be provided in separate servers.

The telecommunications carrier provides the PPPoE net 3 as an IP-VPN of Fiber-To-The-Home (FTTH) between the VM service data center 2 and the router 4. Also, the telecommunications carrier has RAS 20, which are services for connecting to a remote computer network. Using the RAS 20, communication is performed between the virtual router 18 and the router 4 via the PPPoE session.

In a plurality of virtual machines 17 in FIG. 2, one of the virtual machines 17 has started the Web server 19. The Web server 19 constructs the virtual machine 17 by receiving a request from the router 4, and provides the virtual machine 17.

The router 4 reads processing power of the information processing apparatus desired to be provided, that is to say, information specifying the setting of the VM device from the recording medium, and transmits the information to the Web server 19. Specifically, the setting information may be, an OS of the VM device, hardware resources, such as a hard disk capacity, a memory capacity, and applications that are recorded, for example. The user, for example, purchases an SD (Secure Digital) card on which information matching his or her desired VM device settings is recorded, and inserts the SD card into the router 4 so as to request the setting of the VM device.

The router 4 VM device information read from the SD card 7 is notified to the Web server 19, and the Web server 19 transmits the received VM device information to the IT cell managing unit 15. The IT cell managing unit 15 starts the IT cell 11 and the GW cell 12 stored in the database 15A on the basis of the VM device information. The IT cell managing unit 15 stores the ID numbers of a new virtual machine 17 and a new virtual modem 18 into the database 15A, creates a new virtual machine 17 and a new virtual modem 18, and starts them.

In the information managing system 1 configured as described above, when a customer connects the router 4 between the PPPoE net 3 and the customer intranet 5, and inserts the SD card 7, the VM service data center 2 constructs the IT cell 11 in which the customer PC 6 operates the virtual machine 17.

### Configuration of Apparatus

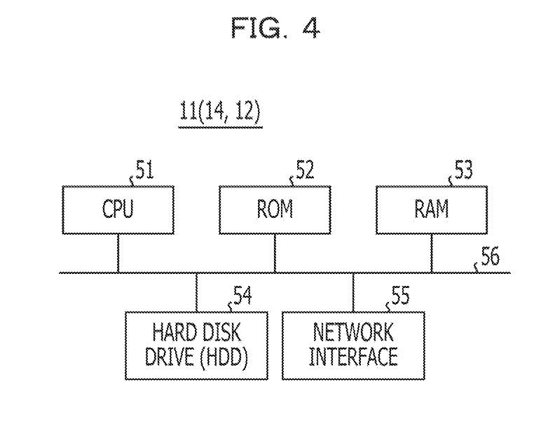

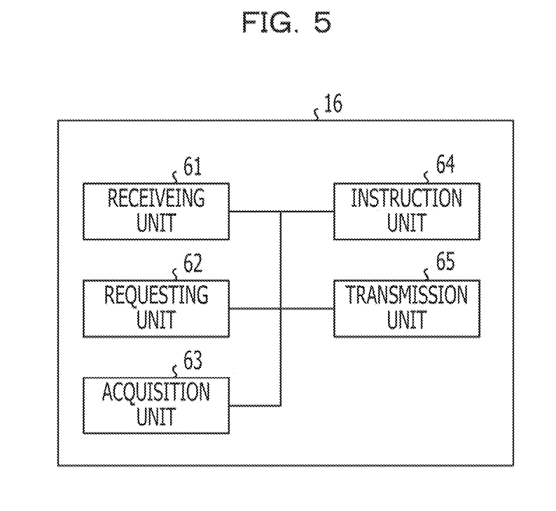

FIG. 4 is a block diagram illustrating a hardware configuration of the IT cell 11. FIG. 5 is a block diagram illustrating a functional configuration of the router managing unit 16 of the managing server 14.

In FIG. 4, the IT cell 11 includes a CPU 51 controlling the entire apparatus, a ROM 52 including a control program, and a RAM 53 functioning as a working area. Also, the IT cell 11 includes a hard disk drive (HDD) 54 including various kinds of information and programs, and a network interface 55 for connecting to the LAN 13.

The CPU 51 is connected to the ROM 52, the RAM 53, the HDD 54, and the network interface 55 through a system bus 56. The hardware configuration of the IT cell 11 is substantially the same as the hardware configuration of the managing server 14 and the GW cell 12, and thus descriptions of the hardware configuration of the managing server 14 and the GW cell 12 will be omitted. In this regard, the IT cell managing unit 15 and the router managing unit 16 in FIG. 2 are achieved by the CPU 51 of the managing server 14 performing a control program stored in the managing server 14. Also, the database 15A in FIG. 2 may be stored in the HDD 54 of the managing server 14.

In FIG. 5, the router managing unit 16 includes a receiving unit 61, a requesting unit 62, an acquisition unit 63, an instruction unit 64, and a transmission unit 65.

When the router 4 is connected between the PPPoE net 3 and the customer intranet 5, the receiving unit 61 receives VM device information from the router 4. The requesting unit 62 requests the telecommunications carrier to create an operation-phase IP-VPN and to create two sets of operation-phase PPPoE setting information. The acquisition unit 63 obtains information on an IT cell 11 to be started, a virtual machine 17 to be started, a virtual router 18 to be started, and a GW cell 12 to be started in the VM service data center 2 on the basis of the VM device information. Here, the information on the IT cell 11 is an ID number identifying an IT cell 11. The information on the virtual machine 17 is an ID number identifying a virtual machine 17. The information on the virtual router 18 is an ID number identifying a virtual router 18. Also, the information on the GW cell 12 is an ID number identifying a GW cell 12.

Further, the acquisition unit 63 obtains two sets of operation-phase PPPoE setting information from the telecommunications carrier. A description will be given of the operation-phase PPPoE setting information later. The instruction unit 64 instructs the IT cell managing unit 15 to start the virtual machine 17 and the virtual router 18 corresponding to information on the virtual machine 17 to be started and information on the virtual router 18 to be started, respectively. The transmission unit 65 transmits one set of operation-phase PPPoE setting information to the router 4, and transmits the other one set of operation-phase PPPoE setting information to the GW cell 12 corresponding to the GW cell 12 to be started. Also, the transmission unit 65 transmits the IP address of the started virtual router 18 to the router 4, and transmits the IP address of the router 4 to the started virtual router 18.

The receiving unit 61, the acquisition unit 63 and the transmission unit 65 are achieved by the CPU 51 and the network interface 55 of the managing server 14. The requesting unit 62 and the instruction unit 64 are achieved by the CPU 51 of the managing server 14 performing a predetermined control program.

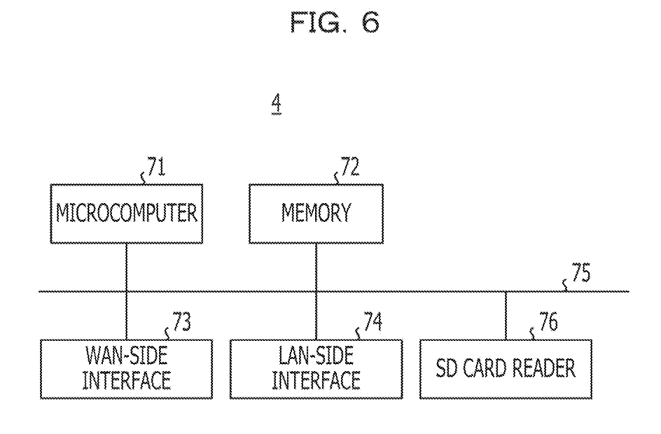

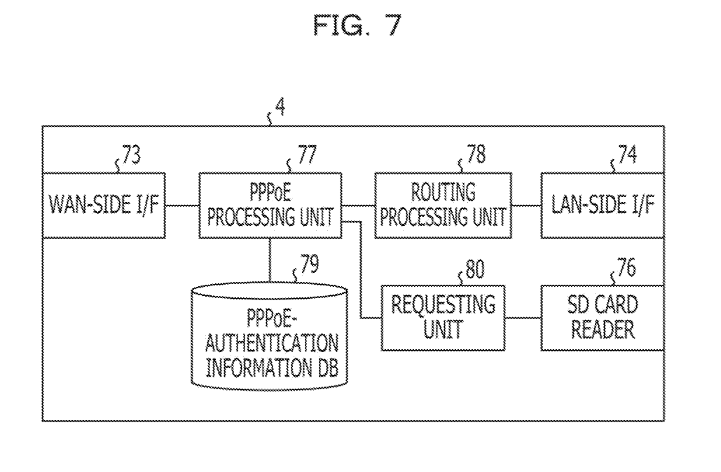

FIG. 6 is a block diagram illustrating a hardware configuration of the router 4. FIG. 7 is a block diagram illustrating a functional configuration of the router 4.

As shown in FIG. 6, the router 4 includes a microcomputer 71 which controls the entire operation of the router 4, and a memory 72 which stores a control program and data. Also, the router 4 includes a WAN (Wide Area Network)-side interface 73 for connecting to the PPPoE net 3, and a LAN-side interface 74 for connecting to the customer intranet 5. Further, the router 4 includes an SD card reader 76. The microcomputer 71 is connected to the memory 72, the WAN-side interface 73, the LAN-side interface 74 and the SD card reader 76 through a bus 75.

The memory 72 stores a script for connecting to a virtual machine, setting-phase PPPoE setting information, and VM device information. The setting-phase PPPoE setting information includes a PPPoE user name and a password. The setting-phase PPPoE setting information is information for the router 4 to connect to the VM service data center 2 for the first time using PPPoE through the PPPoE net 3. The PPPoE user name is, for example, “faucet-user-123456@facet.sop.fujitsu.com”, and consists of a domain name identifying the VM service data center 2 and a specific ID of the router 4. Also, the VM device information stored in the memory 72 is VM device information identifying the IT cell 11 that has started the Web server 19. Accordingly, the virtual machine 17 accessed for the first time by the customer PC 6 through the router 4 is the virtual machine 17 starting the Web server 19.

As shown in FIG. 7, the router 4 includes a PPPoE processing unit 77, a routing processing unit 78, a PPPoE authentication information database (DB) 79, a WAN-side interface 73, and a LAN-side interface 74. Also, the router 4 includes a requesting unit 80 and an SD card reader 76. The PPPoE authentication information DB 79 stores the setting-phase PPPoE setting information. Also, the PPPoE authentication information DB 79 is stored in the memory 72.

The PPPoE processing unit 77 performs processing to connect to the VM service data center 2 for the first time through the PPPoE net 3 using the setting-phase PPPoE setting information stored in the PPPoE authentication information DB 79. Further, the PPPoE processing unit 77 performs processing to connect to the VM service data center 2 through the PPPoE net 3 using the operation-phase PPPoE setting information. The operation-phase PPPoE setting information includes a PPPoE-ID and a password for connecting the router 4 to the operation-phase IP-PVN, and is obtained from the router managing unit 16. The operation-phase PPPoE setting information is one example of setting information of the protocol for the virtual private network. Also, a plurality of customers may access the VM service data center 2 using a same GW cell 12 at setting-phase time, and thus the router managing unit 16 assigns a different GW cell 12 for each customer at operation-phase time so as to increase information security. For this purpose, the setting-phase PPPoE setting information and the operation-phase PPPoE setting information are separated.

The routing processing unit 78 obtains the IP address of the virtual router 18 selected by the IT cell managing unit 15 from the router managing unit 16, and communicates with the virtual router 18 selected by the IT cell managing unit 15 using Ethernet over IP. Thereby, data communication by the Ethernet over IP is performed between the customer PC 6 and the virtual machine 17 selected by the IT cell managing unit 15. The Ethernet over IP is a function of IP-packetizing data (specifically, Ether frames) and transmitting and receiving the data. The PPPoE processing unit 77 and the routing processing unit 78 are achieved by the microcomputer 71 performing the control program stored in the memory 72.

### Description of Processing

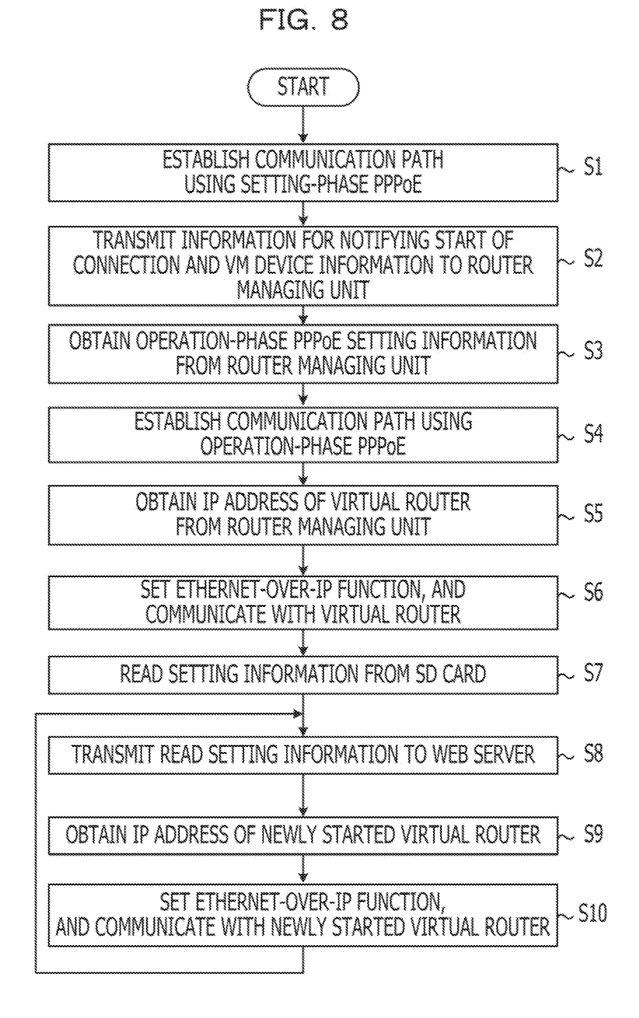

FIG. 8 is a flowchart illustrating a process conducted by the router 4. It is assumed that a customer has connected an optical fiber cable to the WAN-side interface 73 of the router 4, and has connected a LAN cable to the LAN-side interface 74, and the power has been turned on to the router 4.

First, the PPPoE processing unit 77 establishes a communication path to a GW cell 12 via a setting-phase PPPoE using the setting-phase PPPoE setting information stored in the PPPoE authentication information DB 79, that is to say, connects to the setting-phase IP-VPN (step S1). By step S1, the router 4 accesses the GW cell 12 of the VM service data center 2 through the PPPoE net 3.

Next, the PPPoE processing unit 77 transmits information for notifying a connection start and the VM device information stored in the PPPoE authentication information DB 79 to the router managing unit 16 (step S2). The information for notifying the connection start is, for example, a packet indicating a connection start. Also, if the host name of the router managing unit 16 is “faucet-mng.cloud.fujitsu.com”, the PPPoE processing unit 77 transmits a packet indicating a connection start and the VM device information to a destination “http://faucet-mng.cloud.fujitsu.com”. The VM device information transmitted in step S2 is the VM device information identifying an IT cell 11 that has started the Web server 19.

Next, the PPPoE processing unit 77 obtains the operation-phase PPPoE setting information as return information of the VM device information, that is to say, a PPPoE-ID and a password from the router managing unit 16 (step S3). The PPPoE processing unit 77 establishes a communication path to the started GW cell 12 via operation-phase PPPoE using the PPPoE-ID and the password obtained from the router managing unit 16, that is to say, connects to the operation-phase IP-VPN (step S4). By step S4, the router 4 can connect to the started GW cell 12 via a virtual private network using Ethernet.

After that, the routing processing unit 78 obtains the IP address of the virtual router 18 selected by the IT cell managing unit 15 from the router managing unit 16 (step S5). For example, the routing processing unit 78 obtains the IP address of the virtual router 18 selected by the IT cell managing unit 15 from the storage destination “http://faucet-mng.cloud.fujitsu.com/etherip-param” of the virtual router 18 in the router managing unit 16. Here, the IP address of the virtual router 18 selected by the IT cell managing unit 15 is the IP address of the virtual router 18 connected to the IT cell 11 that has stated the Web server 19.

The routing processing unit 78 sets the Ethernet-over-IP function, that is to say, the function of packetizing data, and transmitting and receiving IP packets to/from the virtual router 18 selected by the IT cell managing unit 15. Thereby, it is possible to create a state in which the router 4 is connected to the virtual machine 17 connected to the virtual router 18 selected by the IT cell managing unit 15 as if via Ethernet, that is to say, directly connected to the Web server 19. At the same time, the routing processing unit 78 communicates with the virtual router 18 selected by the IT cell managing unit 15 through a communication path from the started GW cell 12 to the router 4 on the basis of the IP address of the obtained virtual router 18 (step S6). In this regard, the router 4 has DHCP (Dynamic Host Configuration Protocol), and assigns the IP address to the customer PC 6, and thus the virtual machine 17 starting the Web server 19 is connected to the customer PC 6 through the virtual router 18 and the router 4. Also, if the router 4 has table information, etc., which assigns the IP address of the router 4 to the IP address of the customer PC 6, the router 4 may not have DHCP.

By the processes of steps S1 to S6, the customer PC 6 can access the Web server 19 using Ethernet over IP through the router 4, the PPPoE net 3 (IP-VPN), the GW cell 12, and the virtual router 18.

Next, the SD card reader 76 of the router 4 reads the VM device information from an SD (step S7), and the requesting unit 80 transmits the read VM device information to the Web server 19 (step S8).

The routing processing unit 78 inquires of the router managing unit 16 about the IP address of a newly started virtual router 18 at regular intervals on the basis of the VM device information, and obtains the IP address of the virtual router 18 from the router managing unit 16 (step S9). Here, if there is no newly started virtual router 18, the routing processing unit 78 obtains information indicating that there is no newly started virtual router 18 from the router managing unit 16.

The routing processing unit 78 sets the Ethernet-over-IP function, and communicates with the virtual router 18 on the basis of the IP address of the virtual router 18 obtained in step S9 (step S10). After that, the processing returns to step S8.

By the processes of steps S7 to S10, the customer PC 6 can communicate with the newly started virtual machine 17 using Ethernet over IP on the basis of the VM device information read from the SD card. Also, by repeating the processes of steps S8 to S10, the customer PC 6 can communicate with a plurality of the newly started virtual machines 17 using Ethernet over IP.

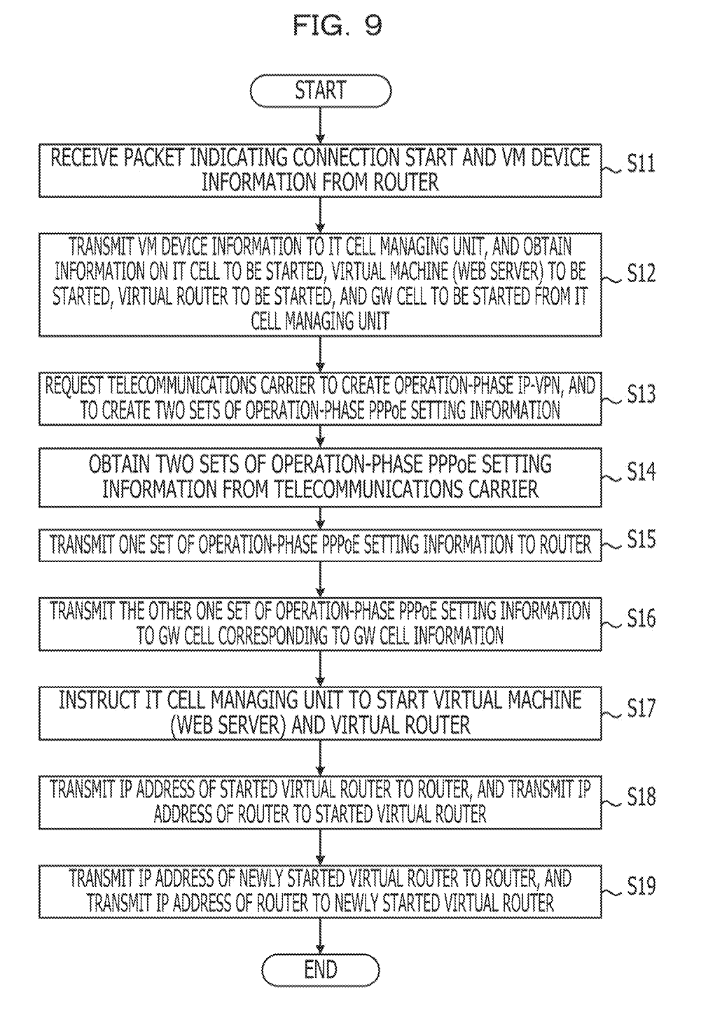

FIG. 9 is a flowchart illustrating a process conducted by the router managing unit 16. The receiving unit 61 receives a packet indicating a connection start and the VM device information from the router 4 (step S11). The acquisition unit 63 transmits the VM device information to the IT cell managing unit 15. And the acquisition unit 63 obtains information on a virtual machine to be started, a virtual router to be started, an IT cell to be started, and information on a GW cell to be started from the IT cell managing unit 15 (step S12). Here, the virtual machine to be started is a virtual machine 17 starting the Web server 19. Also, the virtual router to be started is a virtual router 18 connected to a virtual machine 17 starting the Web server 19. Further, the IT cell to be started is an IT cell 11 including a virtual machine 17 starting the Web server 19.

The requesting unit 62 requests the telecommunications carrier to create an operation-phase IP-VPN and to create two sets of operation-phase PPPoE setting information (step S13). Here, the requesting unit 62 accesses a site (for example, “FLET'S HIKARI NEXT service-application-acceptance page FLET'S VPN wide setting menu”) of a telecommunications carrier, and makes a request. In this regard, the process of step S13 may be performed by an administrator of the VM service data center 2 requesting the telecommunications carrier to create an operation-phase IP-VPN and two sets of operation-phase PPPoE setting information. After that, the telecommunications carrier creates the operation-phase IP-VPN.

The acquisition unit 63 obtains two sets of operation-phase PPPoE setting information from the telecommunications carrier (step S14). Next, the transmission unit 65 transmits one set of operation-phase PPPoE setting information to the router 4 (step S15). In step S15, the PPPoE processing unit 77 of the router 4 establishes a communication path to the GW cell 12 corresponding to the information of the GW cell obtained in step S12 using the operation-phase PPPoE setting information. The transmission unit 65 transmits the other one set of operation-phase PPPoE setting information to the GW cell corresponding to the information of the GW cell obtained in step S12 (step S16). In step S16, the GW cell 12 corresponding to the information of the GW cell obtained in step S12 establishes a communication path to the router 4 using the operation-phase PPPoE setting information.

The instruction unit 64 instructs the IT cell managing unit 15 to start the virtual machine 17 and the virtual router 18 corresponding to the information of the virtual machine 17 to be started and the virtual router 18 to be started, respectively, which has been obtained in step S12 (step S17). After that, the transmission unit 65 transmits the IP address of the started virtual router 18 to the router 4, and transmits the IP address of the router 4 to the started virtual router 18 (step S18). In step S18, the started virtual router 18 sets the Ethernet-over-IP function, that is to say, a function of IP-packetizing data and transmitting and receiving the data. Additionally, the started virtual router 18 communicates with the router 4 through the communication path from the GW cell 12 to the router 4 on the basis of the IP address of the router 4. Also, the router 4 sets the Ethernet-over-IP function, that is to say, the function of IP-packetizing data and transmitting and receiving the data. Also, the router 4 communicates with the started virtual router 18 through the communication path from the GW cell 12 to the router 4 on the basis of the IP address of the virtual router 18.

By the processes of steps S11 to S18, the router managing unit 16 can assist the customer PC 6 in accessing the virtual machine 17 starting the Web server 19 through the router 4, the PPPoE net 3 (IP-VPN), the GW cell 12 and the virtual router 18.

Next, the transmission unit 65 transmits the IP address of a newly started virtual router 18 to the router 4 on the basis of the VM device information specified from the router. Further, the transmission unit 65 transmits the IP address of the router 4 to the newly started virtual router 18 (step S19). By step S19, the newly started virtual router 18 sets the Ethernet-over-IP function, that is to say, the function of IP-packetizing data, and transmitting and receiving the data. The newly started virtual router 18 communicates with the router 4 through the communication path from the GW cell 12 to the router 4 on the basis of the IP address of the router 4. Also, the router 4 sets the Ethernet-over-IP function, that is to say, the function of IP-packetizing data, and transmitting and receiving the data. The router 4 communicates with the newly started virtual router 18 through the communication path from the GW cell 12 to the router 4 on the basis of the IP address of the newly started virtual router 18.

By the process of step S19, the router managing unit 16 can assist the customer PC 6 in accessing the newly started virtual machine 17 through the router 4, the PPPoE net 3 (IP-VPN), the GW cell 12, and the virtual router 18.

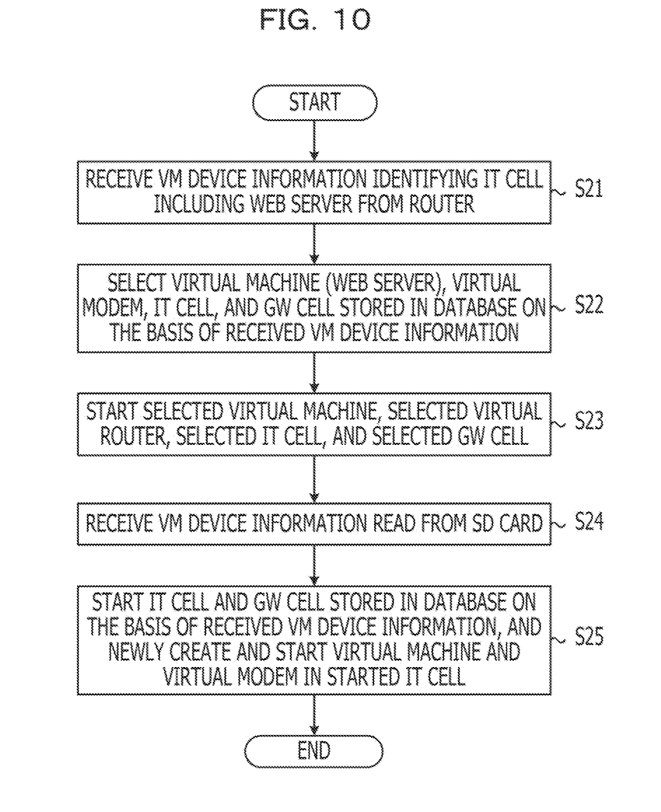

FIG. 10 is a flowchart illustrating a process conducted by the IT cell managing unit 15. First, the IT cell managing unit 15 receives the VM device information identifying the IT cell 11 including the Web server 19 from the router 4 through the router managing unit 16 (step S21). The IT cell managing unit 15 selects the virtual machine 17, the virtual modem 18, the IT cell 11, and the GW cell 12, which are stored in the database 15A on the basis of the received VM device information (step S22). Here, the selected virtual machine 17 is a virtual machine starting the Web server 19. The selected virtual router 18 is a virtual router connected to the virtual machine 17 starting the Web server 19. The selected IT cell 11 is the IT cell including the virtual machine starting the Web server 19 and the virtual router connected to that virtual machine. The IT cell managing unit 15 starts the selected virtual machine 17, the selected virtual router 18, the selected IT cell 11, and the selected GW cell 12 (step S23).

Next, the IT cell managing unit 15 receives the VM device information from the router 4 through the IT cell 11 including the Web server 19 (step S24). The VM device information is VM device information that is read from the SD card by the router 4. The IT cell managing unit 15 starts the IT cell 11 and the GW cell 12, which are stored in the database 15A, on the basis of the received VM device information. And the IT cell managing unit 15 newly creates a virtual machine 17 and a virtual modem 18 in the started IT cell 11, and starts them (step S25).

By this processing, the IT cell managing unit 15 starts the virtual machine 17 starting the Web server 19 on the basis of the VM device information identifying the IT cell 11 including the Web server 19 so that the IT cell managing unit 15 can receive the VM device information from the router 4. Also, the IT cell managing unit 15 can create and start a new virtual machine and a new virtual modem on the basis of the VM device information that the router 4 read from the SD card.

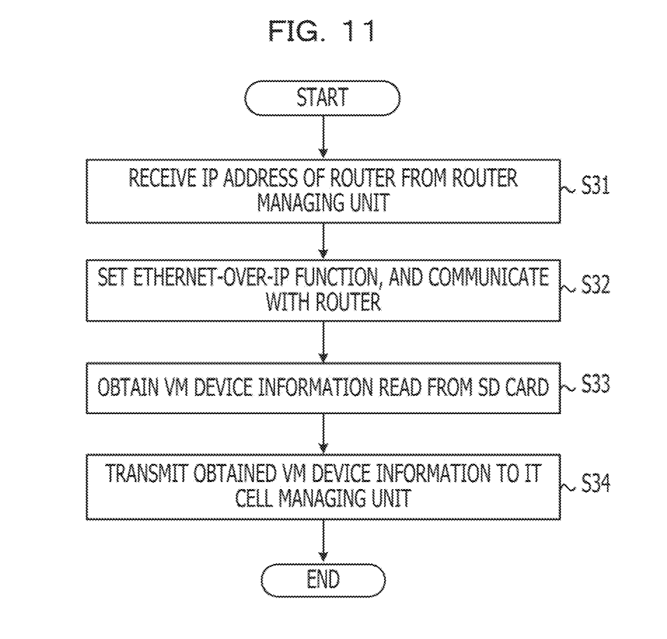

FIG. 11 is a flowchart illustrating a process conducted by the IT cell 11 having the virtual machine 17 starting the Web server 19. In this regard, it is assumed that the virtual machine 17 starting the Web server 19 and the IT cell 11 having the virtual router 18 are started.

The virtual router 18 in the IT cell 11 receives the IP address of the router 4 from the router managing unit 16 (step S31). The virtual router 18 sets the Ethernet-over-IP function, that is to say, the function of IP-packetizing data and transmitting and receiving the data. Additionally, the virtual router 18 communicates with the router 4 through the communication path from the GW cell 12 to the router 4 on the basis of the IP address of the router 4 (step S32).

The Web server 19 obtains the VM device information from the router 4 (step S33). The Web server 19 transmits the VM device information to the IT cell managing unit 15 (step S34). Thereby, the IT cell managing unit 15 selects the IT cell 11 and the GW cell 12 stored in the database 15A on the basis of the received VM device information, and creates a new virtual machine 17 and a new virtual modem 18 in the selected IT cell 11, and starts them.

Here, an example of a first transmission, an acquisition, and a second transmission are provided by the Web server 19 performing steps S33 to S34. The Web server 19 is achieved by the CPU 51 of the IT cell 11 performing predetermined software (for example, a virtual machine application).

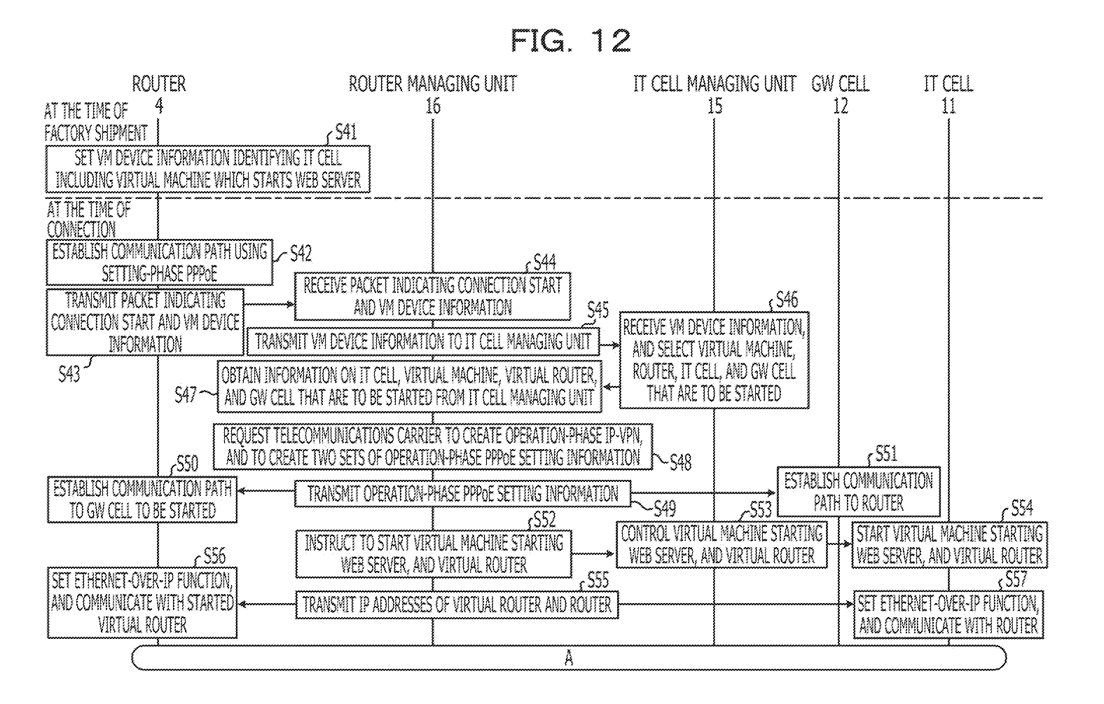

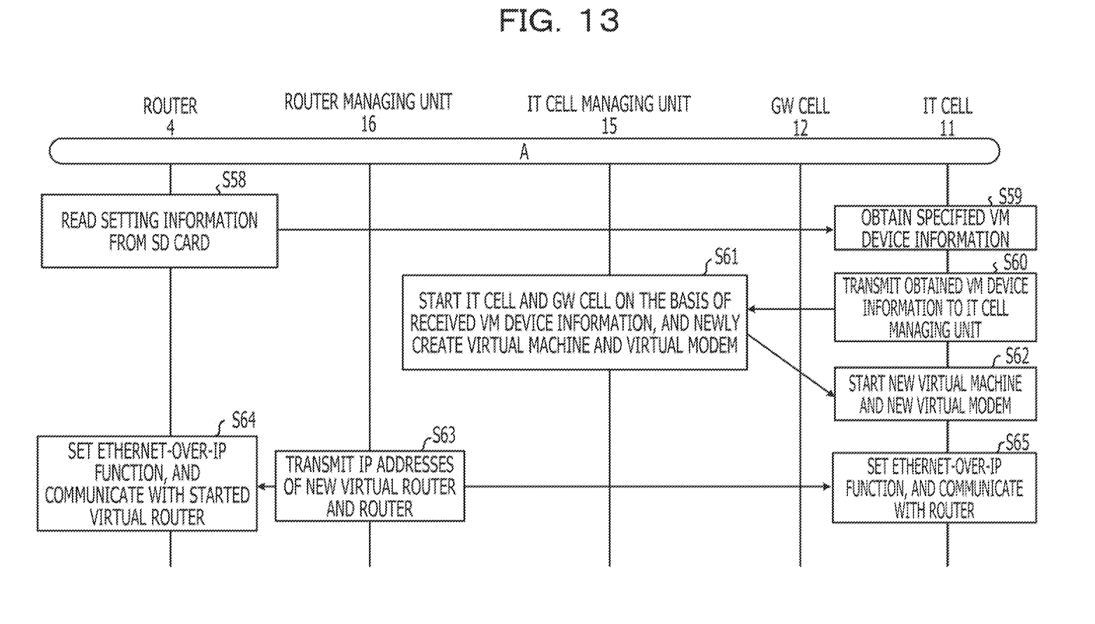

FIG. 12 and FIG. 13 are diagrams illustrating a sequence of processes conducted by the information managing system 1. First, at the time of factory shipment of the router 4, the VM device information identifying the IT cell 11 including the virtual machine 17 starting the Web server 19 is set in the memory 72 of the router 4 (step S41). Next, at the time of connection of the router 4, the PPPoE processing unit 77 of the router 4 establishes a communication path to a GW cell 12 via the setting-phase PPPoE using the setting-phase PPPoE setting information stored in the PPPoE authentication information DB79 (step S42). The PPPoE processing unit 77 of the router 4 transmits a packet indicating a connection start and the VM device information to the router managing unit 16 (step S43).

The router managing unit 16 receives the packet indicating a connection start and the VM device information from the router 4 (step S44). The router managing unit 16 transmits the VM device information to the IT cell managing unit 15 (step S45). The IT cell managing unit 15 receives the VM device information, and selects a virtual machine 17 to be started, a virtual router 18 to be started, an IT cell 11 to be started, and a GW cell 12 to be started (step S46). The virtual machine 17 to be started is a virtual machine starting the Web server 19.

The router managing unit 16 obtains information on the virtual machine 17 to be started, the virtual router 18 to be started, the IT cell 11 to be started, and the GW cell 12 to be started from the IT cell managing unit 15 (step S47). The router managing unit 16 requests the telecommunications carrier to create an operation-phase IP-VPN, and to create two sets of operation-phase PPPoE setting information (step S48). The telecommunications carrier established an operation-phase IP-VPN in response to the request from the router managing unit 16, and returns two sets of operation-phase PPPoE setting information to the router managing unit 16. The router managing unit 16 transmits one set of operation-phase PPPoE setting information to the router 4, and transmits the other one set of the operation-phase PPPoE setting information to the GW cell to be started (step S49).

The PPPoE processing unit 77 of the router 4 establishes a communication path to a GW cell 12 to be started using the operation-phase PPPoE setting information (step S50). Also, the GW cell 12 to be started establishes a communication path to the router 4 using the operation-phase PPPoE setting information (step S51). By steps S50 and S51, it is possible for the router 4 and the GW cell 12 to be started to connect to each other through a virtual private network using Ethernet.

Next, the router managing unit 16 instructs the IT cell managing unit 15 to start the virtual machine 17 and the virtual router 18 corresponding to the information of the virtual machine 17 to be started and the virtual router 18 to be started, respectively, which has been obtained in step S47 (step S52). IT cell managing unit 15 causes the IT cell 11 to start the virtual machine 17 to be started, that is to say, the virtual machine 17 starting the Web server 19 and the virtual router 18 to be started (step S53). The IT cell 11 selected by the IT cell managing unit 15 starts the virtual machine 17 starting the Web server 19 and the virtual router 18 to be started (step S54).

After that, the router managing unit 16 transmits the IP address of the started virtual router 18 to the router 4, and transmits the IP address of the router 4 to the virtual router 18 (step S55). The router 4 receives the IP address of the started virtual router 18 from the router managing unit 16. The router 4 sets the Ethernet-over-IP function, and communicates with the started virtual router 18 through the communication path from the GW cell 12 to the router 4 on the basis of the received IP address (step S56). The started virtual router 18 in the IT cell 11 receives the IP address of the router 4 from the router managing unit 16. The started virtual router 18 sets the Ethernet-over-IP function, that is to say, the function of IP-packetizing data and transmitting and receiving the data. At the same time, the started virtual router 18 communicates with the router 4 through the communication path from the GW cell 12 to the router 4 on the basis of the received IP address (step S57).

By the processes of steps S41 to S57, it becomes possible for the customer PC 6 to communicate with the virtual machine 17 starting the Web server 19.

Next, the router 4 reads the VM device information from the SD card, and returns the selected VM device information to the virtual machine 17 starting the Web server 19 (step S58).

The Web server 19 obtains the VM device information read from the SD card (step S59). The Web server 19 transmits the obtained VM device information to the IT cell managing unit 15 (step S60). The IT cell managing unit 15 starts the IT cell 11 and the GW cell 12 stored in the database 15A on the basis of the received VM device information. The IT cell managing unit 15 creates a new virtual machine 17 and a new virtual modem 18 in the started IT cell 11, and starts them (step S61). Thereby, the new virtual machine 17 and the new virtual modem 18 are started (step S62).

After that, the router managing unit 16 transmits the IP address of the newly started virtual router 18 to the router 4, and transmits the IP address of the router 4 to the newly started virtual router 18 (step S63). The router 4 receives the IP address of the newly started virtual router 18 from the router managing unit 16. The router 4 sets the Ethernet-over-IP function, and communicates with the newly started virtual router 18 on the basis of the received IP address (step S64). The newly started virtual router 18 in the IT cell 11 receives the IP address of the router 4 from the router managing unit 16. The newly started virtual router 18 sets the Ethernet-over-IP function, and communicates with the router 4 on the basis of received IP address (step S65).

By the processes of steps S58 to S65, it becomes possible for the customer PC 6 to communicate with the new virtual machine 17 corresponding to the VM device information read from the SD card.

### Summary of Second Embodiment

As described above, by the second embodiment, when the router 4 is connected between the PPPoE net 3 and the customer PC 6, the Web server 19 running on the virtual machine 17 in the IT cell 11 receives the VM device information recorded on the SD card from the router 4, creates and starts a new virtual machine and a new virtual modem on the basis of the VM device information, and transmits the information to the IT cell managing unit 15. Accordingly, it is possible for a user of the customer PC 6 to select a virtual machine and a virtual modem to be newly started after the installation of the router 4 by selecting an SD card.

A recording medium, on which a program for achieving the function of the IT cell 11 including the Web server 19 is recorded, may by supplied to the IT cell 11, and the CPU 51 of the IT cell 11 may perform the program stored in the recording medium. Also, a recording medium, on which a program for achieving the function of the IT cell managing unit 15 or the router managing unit 16 is recorded, may be supplied to the managing server 14, and the CPU 51 of the managing server 14 may perform the program stored in the recording medium. The storage medium for supplying the program includes, for example, a CD-ROM (Compact Disk Read Only Memory), a DVD (Digital Versatile Disk), or an SD (Secure Digital) memory card, and the like.

Also, the same advantageous effect as that of the above-described embodiments is achieved by the CPU 51 of the IT cell 11 performing the program of the software for achieving the function of the Web server 19, the virtual machine 17, and the virtual router 18. Substantially the same advantageous effect as those of the above-described embodiments is also achieved by the CPU 51 of the managing server 14 performing the program of the software for achieving the function of the IT cell managing unit 15 or the router managing unit 16.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A router comprising:
a routing unit performing routing between a virtual private network and an external apparatus;
a reading unit reading, from a recording medium, information specifying processing power of an information processing apparatus communicating with the external apparatus through the virtual private network; and
a requesting unit transmitting the information read by the reading unit and requesting provision of an information processing apparatus satisfying the specification of the processing power.

2. The router according to claim 1,
wherein when the reading unit starts accessing a portable recording medium, the reading unit reads the information recorded on the portable recording medium.

3. The router according to claim 1,
wherein the requesting unit transmits the information to an apparatus having a predetermined network address, and the apparatus having received the information constructs a virtual machine satisfying the processing power specified by the information in order to provide the virtual machine as the information processing apparatus.

4. The router according to claim 1,
wherein hardware resources held by the information processing apparatus and an operating system executed by the information processing apparatus are specified as the processing power.

5. The router according to claim 2,
wherein hardware resources held by the information processing apparatus and an operating system executed by the information processing apparatus are specified as the processing power.

6. The router according to claim 3,
wherein hardware resources held by the information processing apparatus and an operating system executed by the information processing apparatus are specified as the processing power.

7. A method of routing, comprising:
reading, from a recording medium, information specifying processing power of an information processing apparatus communicating with an external apparatus through a virtual private network;
transmitting the read information and requesting provision of an information processing apparatus satisfying the specification of the processing power; and
performing routing between the virtual private network and the external apparatus to relay communication between the external apparatus and the information processing apparatus.

8. A computer-readable recording medium storing a program causing a computer to perform processing comprising:
reading, from a recording medium, information specifying processing power of an information processing apparatus communicating with an external apparatus through a virtual private network;
transmitting the read information and requesting provision of an information processing apparatus satisfying the specification of the processing power; and
performing routing between the virtual private network and the external apparatus to relay communication between the external apparatus and the information processing apparatus.

9. An information processing apparatus comprising:
a receiving unit receiving information specifying processing power of an information processing apparatus to be provided from a router connected through a virtual private network to an external apparatus connected through the router;
a virtual-machine managing unit constructing a virtual machine satisfying the processing power specified by the information; and
a transmission unit transmitting information regarding the virtual machine to the router.

10. A method of constructing a virtual machine, comprising:
receiving information specifying processing power of an information processing apparatus to be provided from a router connected through a virtual private network to an external apparatus connected through the router;
constructing a virtual machine satisfying the processing power specified by the information; and
transmitting information regarding the virtual machine to the router.

11. A computer-readable, non-transitory medium storing a program causing a computer to perform processing comprising:
receiving information specifying processing power of an information processing apparatus to be provided from a router connected through a virtual private network to an external apparatus connected through the router;
constructing a virtual machine satisfying the processing power specified by the information; and
transmitting information regarding the virtual machine to the router.
